(19) United States
(12) Patent Application Publication
(10) Pub. No.: US 2022/0050216 A1
(43) Pub. Date: Feb. 17, 2022

(54) REMOTE FIELD OF VIEW DETECTOR AND DISPLAY

(71) Applicant: Thales Holdings UK Plc, Reading, Berkshire (GB)

(72) Inventor: Amyas GODFREY, Bristol (GB)

(21) Appl. No.: 17/297,536

(22) PCT Filed: Nov. 28, 2019
(86) PCT No.: PCT/GB2019/053368

§ 371 Date: May 27, 2021

(30) Foreign Application Priority Data
Nov. 30, 2018 (GB) 1819583.4

(51) Int. Cl. G01S 19/49; F41G 3/14; H04L 29/08

(52) U.S. Cl. CPC G01S 19/49; F41G 3/14; F41G 3/04; H04L 67/12; H04L 67/26

(57) ABSTRACT

A field of view detector comprising an orientation sensor for determining an orientation of the field of view detector, a location sensor for determining a location of the field of view detector, and a communication system, the field of view detector configured to communicate the orientation and location of the field of view detector to a central device using the communications system.

### FIELD

Described herein is a field of view detector and a central device, which, for example, can be used to determine and display a field of view. The present invention also relates to an associated method of using a field of view detector and a central device.

### BACKGROUND

In many situations, it is desirable to have and use information from different, remote locations. This can be difficult in dynamic situations.

It is at least one objective of at least one embodiment of the present invention to provide an improved information source, such as an improved remote information source.

### SUMMARY

Aspects of the present disclosure are defined by the independent claims appended herewith. Preferred features are defined by the dependent claims appended herewith.

According to a first aspect of the present disclosure there is provided a field of view detector, which may comprise one or more or each of: an orientation sensor, a location sensor, a processor and a communication system. The processor may be comprised in the communication system. The orientation sensor may be configured to determine an orientation, such as an orientation of the field of view detector. The location sensor may be configured to determine a location, such as a location of the field of view detector. The field of view detector and/or the communication device may be configured to communicate an orientation and/or a location of the field of view detector to a central device and/or to another field of view detector. The central device and/or the other field of view detector may be remote from the field of view detector.

The field of view detector may be provided on, comprise or be comprised in an article to be worn, which may be an article of clothing, such as an article of personal protective equipment (PPE). The article may be an item of headgear such as, for example, a helmet, hat, protective goggles, eyewear or headband. The field of view detector may be retrofitted or retrofittable to a helmet. The orientation and/or location of the field of view detector may correspond to the orientation and/or location of a wearer of the article. For example, when the field of view detector is provided on, comprises or is comprised in a helmet or another item of headgear, the orientation of the field of view detector may correspond to the direction in which the wearer of the helmet or other item of headgear is facing or looking, regardless of the direction of travel of the wearer or the orientation of the torso of the wearer.

The field of view detector may comprise or be comprised in a rotatable structure, such as a turret, for example a turret on a vehicle. The orientation and/or location of the field of view detector may correspond to the orientation and/or location of the turret. For example, the orientation of the field of view detector may correspond to the direction in which the turret is facing, regardless of the direction of travel of the vehicle.

The field of view detector may be configured to communicate an alert to the central device and/or another field of view detector. The field of view detector may be configured to push the location and/or orientation of the field of view detector, for example to a central device. The field of view detector may be configured to push the location and/or orientation of the field of view detector and an alert to a central device. The field of view detector may comprise a push initiator, such as a button. The push initiator may initiate the push of the location and/or orientation of the field of view detector, for example, to a central device. The push of the location and/or orientation of the field of view detector to a central device may be used to alert the central device, for example, to alert the central device to an incoming threat, and/or to set a field of view of the field of view detector.

The field of view detector may be configured to continuously or periodically to communicate an orientation and/or a location of the field of view detector to a central device and/or to another field of view detector. The field of view detector may be configured to communicate an orientation and/or a location of the field of view detector to a central device and/or to another field of view detector with a set frequency, such as every 1 second, every 5 seconds, every 10 seconds, or every 30 second.

The field of view detector may be configured to receive the location and/or orientation of an other field of view detector. The field of view detector may be configured to calculate the relative position and/or orientation of the other field of view detector. The field of view detector may be configured to receive or determine a relative position of the field of view detector to a triangulation point between the fields of view of a plurality of fields of view detectors.

The field of view detector may comprise a display. The display may comprise a strip of lights, such as a strip of LEDs. The field of view detector may comprise a direction indicator, which may be comprised in or provided by the display. The direction indicator may indicate a direction to a user or wearer of the field of view detector, for example, by turning on a light in a strip of lights, wherein the light is orientated relative to the user or wearer of the field of view detector towards an indicated direction. The direction indicator may be for indicating a direction in which the user or wearer should face. For example, where the field of view detector comprises or is comprised in a helmet, the helmet may comprise a strip of LEDs inside the brim of the helmet, and a direction is indicated to the wearer of the helmet by turning on the LED in the appropriate direction. The indicated direction may be the relative position and/or orientation of the other field of view detector and/or otherwise indicate the position and/or orientation of the other field of view detector. The indicated direction may be a direction received from the central device. The indicated direction may be a direction towards the triangulation point between the fields of view of a plurality of fields of view detectors.

The orientation sensor may comprise a direction sensor. The orientation sensor may comprise a compass, such as a digital magnetic compass.

The location sensor may comprise a locator or tracker, such as a satellite positioning locator or tracker, such as a GPS, GLONASS, Gallileo, BeiDou, or other suitable satellite positioning system locator. The location sensor may comprise or be wirelessly or physically connected or connectable to a radio, cellular phone or other communications device with a satellite positioning locator or tracker.

According to a second aspect of the present disclosure there is provided a central device, which may comprise a communication system, a processor and/or a display.

The central device may be configured to receive an orientation and/or a location from one or more field of view detectors, such as field of view detectors of the first aspect of the present disclosure. The received orientation and/or a location may be the orientation and/or a location of the one or more field of view detectors. The central device may be configured to display the orientation and/or location of one or more field of view detectors. For example, the central device may be configured to display the location and/or orientation of one or more field of view detectors on a map and/or as numerical data.

The central device may be configured to display the location of a field of view detector using a marker on a map, such as a dot. The central device may be configured to display the orientation of a field of view detector using an arrow on a map. A base of the arrow may correspond to the location of the field of view detector.

The central device may be configured to display a field of view or respective fields of view using the orientation and location of one or more field of view detectors. The central device may be configured to display a respective field of view of a respective field of view detector as an arc, triangle, or other shape that gets wider as it extends from the location of the respective field of view detector. For example, the central device may be configured to display a pair of lines, triangle, wedge, circular sector, arc, and/or similar, to represent the field of view of a field of view detector. The respective field of view may correspond to the field of view of a user or wearer of the respective field of view detector.

The central device may be configured to display multiple fields of view of multiple field of view detectors. The central device may be configured to display an aggregate or combined field of view of multiple fields of view of multiple field of view detectors.

The central device may be configured to calculate and/or display a triangulation using the orientation and location of two or more field of view detectors. The central device may be configured to calculate and/or display a triangulation point from the intersection of the orientations of two or more field of view detectors. The central device may be configured to calculate and/or display a line from each location of two or more field of view detectors, the lines orientated in the orientation of the field of view detectors. The central device may be configured to display a triangulation point as the intersection of lines from the locations of each of two or more field of view detectors, the lines orientated in the orientation of the field of view detectors. The central device may be configured to display a triangulation point as a marker, such as a dot.

The central device may be configured to display a location, orientation and/or field of view of one or more of the field of view detectors. The display of the location, orientation and/or field of view is representative of another property of the respective field of view detector and/or a user or wearer of the field of view detector. For example, the extent (e.g. size or length) of an arrow representing an orientation or the extent of a wedge representing a field of view may represent a range of a user or wearer of the field of view detector, such as a range of a field of view or of a weapon of the wearer or user of the field of view detector.

The central device may be configured to calculate and/or display an average or cumulative location, orientation and/or field of view of the one or more field of view detectors. For example, the display of the location, orientation and/or field of view by the central device may be representative of average or cumulative movements, orientations and/or other properties of the one or more field of view detectors and/or of respective users or wearers of the one or more field of view detectors over time, e.g. over a set or pre-set period of time. For example, the extent of the left and right edges of the representative wedge or triangle (e.g. arc) may represent an average or cumulative orientation, or the extent of a wedge may represent an average or cumulative range (i.e. area observed), of a respective user or wearer of the one or more field of view detectors over the set or pre-set period of time (e.g. 10 sec, 60 sec, 300 sec, etc.). In this way, the central device may better display how each field of view detector is oriented, and may better avoid transient effects due to momentary glances away. When a cumulative field of view for the users or wearers of the one of more field of view detectors is displayed, then this may give information on areas surveyed or covered over the set or pre-set timeframe, which may be particularly useful in certain applications, such as searching applications.

The central device may be configured to continuously and/or periodically receive the location and/or orientation from one or more field of view detectors. The central device may be configured to request (pull) the location and/or orientation of a field of view detector.

The central device may be a smartphone, tablet, laptop, or similar portable electronic device.

The field of view of the field of view detector may be calculated by the processor of the field of view detector and communicated to the central device, and/or calculated by the processor of the central device, e.g. from the location and orientation of the field of view detector.

The field of view detector of the first aspect of the present disclosure and/or the central device of the second aspect of the present disclosure may be configured to determine the field of view of the field of view detector. The field of view detector of the first aspect of the present disclosure and/or the central device of the second aspect of the present disclosure may be configured to determine the width of the field of view of the field of view detector.

The communication system of the field of view detector of the first aspect of the present disclosure and/or the communication system of the central device of the second aspect of the present disclosure may comprise or be wirelessly or physically connected or connectable to a radio or other communications device, such as a radio with a satellite positioning locator or tracker. The communication system of the field of view detector of the first aspect of the present disclosure and/or the communication system of the central device of the second aspect of the present disclosure may comprise a headset, such as a speaker (e.g. headphones) and a microphone. The headset may allow verbal communication.

The field of view detector of the first aspect of the present disclosure and/or the central device of the second aspect of the present disclosure may comprise military grade electronics.

The field of view detector of the first aspect of the present disclosure and/or the central device of the second aspect of the present disclosure may comprise a power source, such as a battery. The power source may power the field of view detector of the first aspect of the present disclosure and/or the central device of the second aspect of the present disclosure, and/or any of the individual components of the field of view detector of the first aspect of the present disclosure and/or the central device of the second aspect of the present disclosure.

According to a third aspect of the present invention is a system comprising the central device of the second aspect and one or more field of view detectors according to the first aspect. The system may comprise a plurality of field of view detectors according to the first aspect.

According to a fourth aspect of the present disclosure there is provided a method of displaying a field of view of a field of view detector. The method may comprise:

using a location and an orientation of a field of view detector to set or define a field of view of the field of view detector; and

displaying the field of view of the field of view detector, for example, using a central device.

The central device may be remote from the field of view detector. The field of view detector may be or comprise the field of view detector of the first aspect. The central device may be or comprise the central device of the second aspect. The method may comprise determining the centre of the field of view of a field of view detector using the orientation of the field of view detector. The method may comprise defining the centre of the field of view of a field of view detector as the orientation of the field of view detector.

The method may comprise, using the central device to display the location, orientation and/or field of view representative of average or cumulative movements, orientations and/or other properties of the one or more field of view detectors and/or of respective users or wearers of the one or more field of view detectors over time, e.g. over a set or pre-set period of time. The method may comprise defining the centre of the field of view of a field of view detector as the average orientation of the field of view detector, such as the average orientation over a set period of time, such as the average orientation over a 1 second, 5 second, 10 second, 30 second, 60 second, 300 second or more period of time. The method may comprise using an average orientation of the field of view detector to prevent the display of the field of view of the field of view detector from changing too quickly or from seemingly shaking due to small and/or incidental movements of the field of view detector.

The method may comprise defining the width of the field of view of a field of view detector as a set or pre-set value, such as a set or pre-set value between 60° and 200°, for example, 120°. The method may comprise defining the field of view of a field of view detector as half of the set or pre-set value either side of the orientation of the field of view detector.

The method may comprise a user or wearer of a field of view detector setting or determining the width of the field of view of a field of view detector. The method may comprise setting or determining the width of the field of view of a field of view detector using limits set or determined by a user or wearer of the field of view detector. For example, the method may comprise orientating the field of view detector (e.g. by a wearer of a helmet-mounted field of view detector turning their head to direct the field of view detector) towards a first limit of the field of view (e.g. towards a leftmost limit of their field of view) and towards a second limit of the field of view (e.g. towards a rightmost limit of their field of view). The method may comprise setting or defining the field of view of the field of view detector using the first limit and the second limit. The method may comprise setting or defining the field of view as between the first limit and the second limit. One skilled in the art will understand that the real-time field of view of a field of view detector will change as the orientation of the field of view detector is changed to set the first limit and second limit, but that in this context, the field of view being set or defined by the first limit and second limit is a central or average field of view of the field of view detector.

According to a fifth aspect of the present invention there is provided a method of determining the location of a target or object. The method may comprise:

receiving the location and orientation of two of more field of view detectors; and

triangulating the intersection of two or more of the two or more orientations.

The method may comprise receiving the location and orientation of two of more field of view detectors using a central device, which may be remote from at least one or all of the two or more field of view detectors. The method may comprise receiving the location and orientation of a field of view detector. The location and orientation of the field of view detector may be pushed by the field of view detector to the central device. The method may comprise receiving the location and orientation of the field of view detector, wherein the central device has requested (pulled) the location and orientation of the field of view detector from the field of view detector.

The central device may be remote from the field of view detector. The field of view detector may be or comprise the field of view detector of the first aspect. The central device may be or comprise the central device of the second aspect. The method may be performed using the field of view detector of the first aspect and/or the central device of the second aspect.

The method may comprise calculating intersections of more than two orientations. The method may comprise defining a triangulation point as the average of the intersections of more than two orientations.

The method may comprise displaying the triangulated intersection, for example, using the central device.

The method may comprise directing a user of a field of view detector towards the triangulated point, for example, using a direction indicator. The method may comprise using the location and orientation of the field of view detector to calculate the relative position of the field of view detector to the triangulation point. The method may comprise using the relative position of the field of view detector to the triangulation point to determine the direction in which a user of the field of view detector should be directed to direct the user towards the triangulation point. The method may comprise changing the direction indicated to the user of the field of view detector as the orientation of the field of view detector changes, such that the user of the field of view detector is directed towards the triangulation point as the user changes their orientation.

According to a sixth aspect of the present disclosure there is provided a computer program product that, when implemented on a processing system and/or processor such as the processing system and/or processor of the field of view detector of the first aspect of the present disclosure and/or the processor of the central device of the second aspect, causes the processing system, field of view detector or central device to implement the method of the third aspect or the fourth aspect. The computer program product may be embodied on a non-transient computer readable medium.

The computer program may comprise computer-executable instructions that, when executed by a processor, enable a computer comprising the processor to perform the method of the third aspect of the present disclosure or the fourth aspect of the present disclosure.

It should be understood that the methods of the third and fourth aspects of the present disclosure can be combined. It should also be understood that the methods of third and fourth aspects of the present disclosure can be performed using the field of view detector of the first aspect of the present disclosure and the central device of the second aspect of the present disclosure.

It should be understood that the individual features and/or combinations of features defined above in accordance with any aspect of the present disclosure or below in relation to any specific embodiment of the disclosure may be utilised, either separately and individually, alone or in combination with any other defined feature, in any other aspect or embodiment of the disclosure.

Furthermore, the present disclosure is intended to cover apparatus configured to perform any feature described herein in relation to a method and/or a method of using or producing, using or manufacturing any apparatus feature described herein.

### BRIEF DESCRIPTION OF THE DRAWINGS

At least one embodiment of the disclosure will now be described, by way of example only, with reference to the accompanying drawings, in which:

FIG. 1 shows a basis user with a field of view detector in a helmet, and a commander with a field of view detector and a central device;

FIG. 2 shows different displays of field of location and orientation information;

FIG. 3 shows a display of multiple fields of view;

FIG. 4 shows a display of a triangulation; and

FIGS. 5A-C show a method of setting a field of view.

### DETAILED DESCRIPTION OF THE DRAWINGS

Although an example is given that is explained with reference to a commander 110 and basic user(s) 105, and that this could potentially refer to a battlefield situation, it will be appreciated that the present disclosure is not limited to this. For example, the same approach may be beneficial in any suitable application in which several users or unit need to be coordinated, particularly applications that require a watch, outlook or survey to be made. Examples of possible alternative applications include coordinating security around a building or person, surveillance operations, searching operations, coordinating a group of workers, setting up a 3D virtual reality recording, and/or the like.

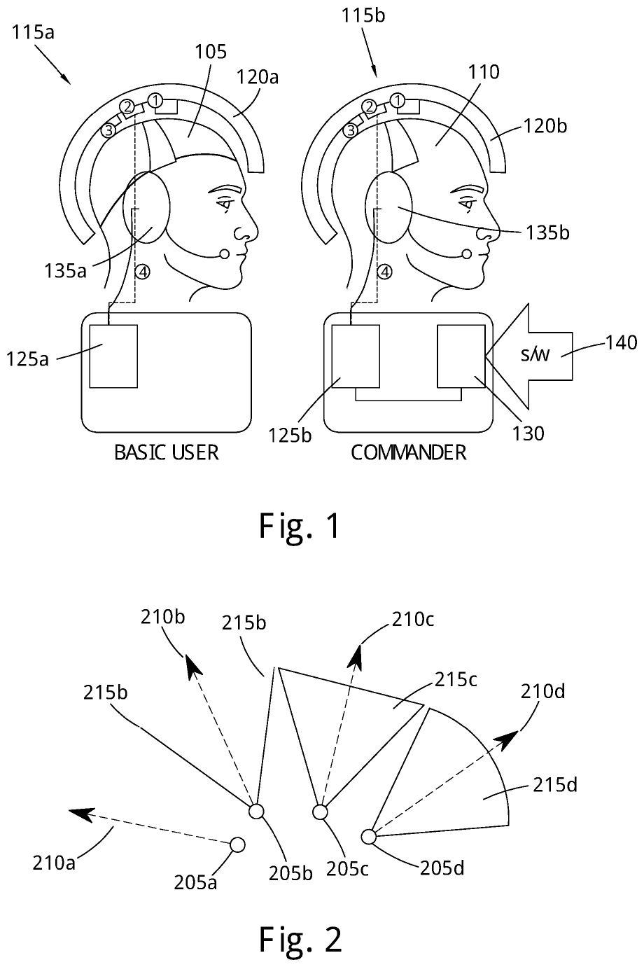

FIG. 1 shows a basic user 105 and a commander 110, who each have field of view detectors 115a-b. Each field of view detector 115a-b comprises a digital magnetic compass 1, a battery 2 and a processor 3, located inside a helmet 120a-b. Each field of view detector 115a-b includes (or is wired or wirelessly connected/connectable to) a communications device, which in this case is a radio 125a-b, and each communications device includes a positioning system, such as a satellite positioning system, e.g. a GPS tracker. Each field of view detector 115a-b is powered by the corresponding battery 2. The basic user 105 and the commander 110 both have headsets 135a-b, which each comprise headphones and a microphone. The headsets 135a-b are communicatively connected 4 to the corresponding radios 125a-b, allowing verbal communication between the basic user 105 and the commander 110. The radios 125a-b communicate the location obtained from the positioning system and orientation obtained from the digital magnetic compass 1 of each of the field of view detectors 115a-b to a central device 130.

The commander 110 has the central device 130, which utilises software 140 to calculate fields of view of each field of view detector 115a-b, and displays the fields of view, ether individually, selectively or as a combined or aggregated field of view.

FIG. 2 shows examples of different methods that could be used for displaying the locations 205a-d and the orientations 210a-d of multiple field of view detectors. Each location 205a-d may be displayed as a simple marker or dot. Each orientation 210a-d may be displayed as an arrow pointing in a direction of the orientation 210a-d (e.g. orientation vector) of the corresponding field of view detector, each arrow originating from the respective location 205a-d of the corresponding field of view detector and extending at the angle of the respective orientation 210a-d. The fields of view 215b-d of some of the field of view detectors is additionally shown. The fields of view 215b-d of the field of view detectors may be represented by a pair of lines 215b, a triangle 215c or a circular sector 215d. The representation of the fields of view, e.g. the angle subtended by the pair of lines 215b, triangle 215c, or circular sector 215d may represent an extent of the respective field of view. The length of the lines 215b, or the size of the triangle 215c or circular sector 215d may represent a range, such as the range of a weapon of a user located at the location 205b-d of the corresponding field of view detectors. Any of these displays of location 205a-d, orientation 210a-d and fields of view 215b-d can be used in combination, and may be displayed on a map by the central device. Each field of view 215b-d is centred on the corresponding orientation 210b-d (e.g. orientation vector).

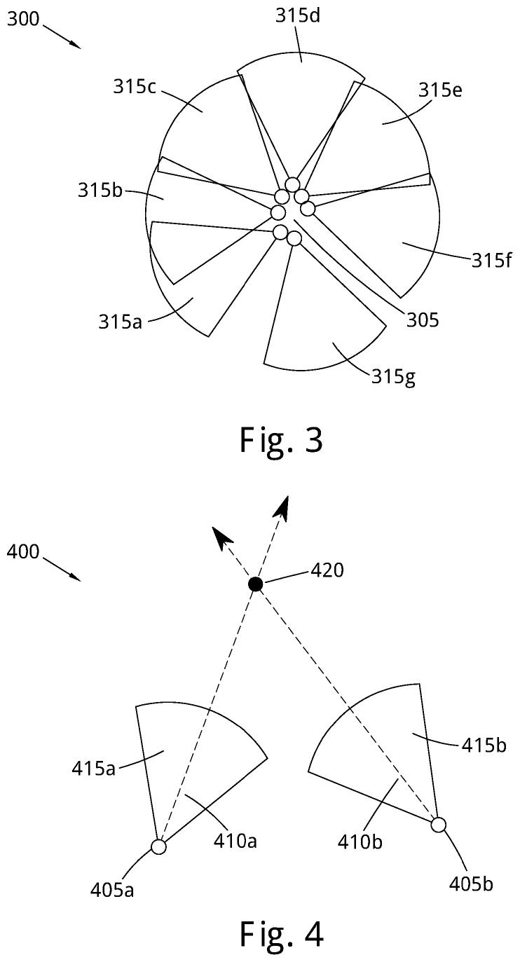

FIG. 3 shows a display 300 of the locations 305 and fields of view 315a-g of multiple field of view detectors that could be displayed on the central device, for example. The locations 305 of the field of view detectors are clustered together, with each field of view detector orientated outwards, away from the cluster of field of view detectors. Such an arrangement may occur when soldiers adopt a defensive position and wish to look out for threats from any direction. The commander can quickly and easily see from the display 300 where fields of view 315a-g overlap, and where there are gaps between fields of view 315a-g. From the display 300 it is clear that the combined fields of view 315a-g do not provide 360° degree coverage, but that there are gaps in the coverage either side of field of view 315g. A commander can quickly and easily see this from the display 300 and issue orders for the soldiers to re-position to correct this deficiency.

The commander can learn about the deficiency without visiting each soldier to individually check each field of view, and without verbally communicating with each soldier to check each field of view. This improves the safety of the commander and the soldiers, as movement and noise are limited, both of which way be undesirable in a combat situation. Although the commander is only provided with very basic location and orientation information from each soldier, the value of the collective information obtained from each soldier is high to the commander. Where the field of view detectors include direction indicators, the commander can use the direction indicators to non-verbally and remotely command the soldiers to reposition or to re-orient their fields of view, allowing the deficiency to be corrected with a minimum amount of movement and noise.

The collective information can be of particular value to the commander when the location and orientation of every soldier is known. If the location and orientation of every soldier is not known, then the collective field of view display 300 may provide less useful information on the overall coverage of the combined fields of view, as any gaps in the display 300 may in fact be filled by soldiers whose location and orientation are not known. The need for location and orientation information from every soldier necessitates the use of simple and light equipment which can be provided to every soldier, and which every soldier can easily use. If the field of view detectors were expensive, heavy, or difficult to use, then it may be unpractical to provide every soldier with the field of view detectors or the required training to properly use the field of view detectors.

Although the collective information is highly useful, it does not require a high degree of accuracy to be useful. High-end digital magnetic compasses which give highly accurate bearings, such as the digital magnetic compasses used along with laser range finders as high-end target locators, suffer from calibration drift. Such high-end digital magnetic compasses have to be periodically recalibrated to ensure their accuracy. Conversely, simply digital magnetic compasses may have an error of 5°, which renders them useless for current target locators. However, a 5° error is adequate for the purposes of displaying fields of view of field of view detectors, and so simple digital magnetic compasses are suitable for the current application. Such simple digital magnetic compasses also have sufficiently low power requirements that they can be always on, thereby always providing a commander with the useful orientation information required for the present application.

One possible field of view detector is a camera, which could provide a commander with good information on the field of view of a soldier. It would be possible for a commander to determine if there were overlaps in the camera images of different soldiers. However, sending imagery from remote soldiers to a central device would require much greater bandwidth, which may not be available. The use of simple location and orientation information, such as that provided by a satellite positioning locator and a simple electronic compass, allows the commander to obtain the useful information with greatly reduced bandwidth, which is highly advantageous.

FIG. 4 shows a display 400 of a triangulation point 420 which has been determined from the intersection of orientations 410a-b of two field of view detectors. The display 400 shows the locations 405a-b of the field of view detectors and the fields of view 415a-b of the field of view detectors. The orientations 410a-b of the associated field of view detectors at the locations 405a, 405b are displayed as arrows which have been extended to or beyond the point at which they intersect, i.e. the triangulation point 420. The triangulation point 420 is calculated by the central device from the intersection of the orientations 410a-b. The simple orientation and location information from two of more field of view detectors can simply be used to determine the triangulation point, which may relate to a target position. The central device is prompted to calculate the triangulation point 420 by the user of one or both of the field of view detectors pushing orientation and location information to the central device, e.g. by using a push initiator of the field of view detectors.

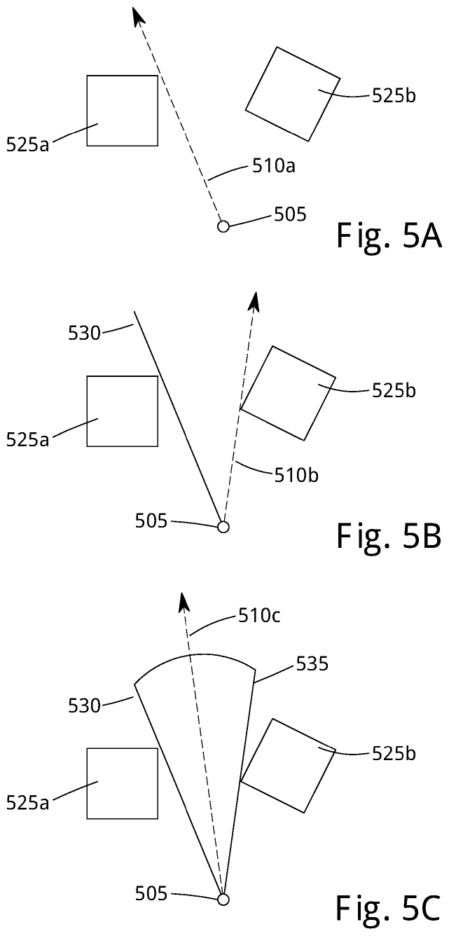

FIGS. 5A-C show a method of setting an extent, e.g. a width or lateral extent, of the field of view of a field of view detector. In some situations, the field of view of a user of a field of view detector may be limited, for example by obstacles 525a-b, and the user may wish set their field of view, rather than using a predefined value for their field of view.

FIG. 5A shows the first step, in which a field of view detector is orientated 510a to a leftmost limit of the field of view of the user of the field of view detector. The user uses the push initiator to set this orientation 510a as the leftmost limit 530 of their field of view 515.

FIG. 5B shows the second step, in which a field of view detector is orientated 510b to a rightmost limit of the field of view of the user of the field of view detector, without changing the location 505 of the field of view detector. The user uses the push initiator to set this orientation 510b as the rightmost limit 535 of their field of view 515.

FIG. 5C shows the set field of view 515, which is defined by the leftmost limit 530 and the rightmost limit 535, which are between the obstacles 525a-b. The orientation 510c is shown in the centre of the field of view 515.

The set field of view can be used until further notice, e.g. until the user selects the default pre-set value or sets another custom field of view. As the leftmost and rightmost limits of the field of view are determined, the angle subtended by these fields of view can be used to help determine future fields of view centred on a measured orientation.

Using this simple method of orientating the field of view detector to the leftmost and rightmost limits of the field of view of the user of the field of view detector, a central device can display a field of view which is limited by obstacles, thereby increasing the accuracy of the information available to the commander. In obstructed situations, if the central device displayed a field of view of predetermined width, the commander would not accurately be aware of what the user of the field of view detector could actually see. This method allows an actual field of view to quickly and easily be set.

Although a central device is referred to herein, the alternative terms “remote device” or “information device” or simply “further device” may be used interchangeably throughout. The above examples are provided by way of illustration only and a skilled person would appreciate that modifications to the above examples could be made.

As such, the scope of invention is not limited by the above examples but only by the claims.

1. A field of view detector comprising an orientation sensor for determining an orientation of the field of view detector, a location sensor for determining a location of the field of view detector, and a communication system, the field of view detector configured to communicate the orientation and location of the field of view detector to a central device using the communications system.

2. The field of view detector of claim 1, wherein the field of view detector comprises or is comprised in a helmet or other item of headwear or in a vehicle, rotatable module or turret on a vehicle.

3. The field of view detector of claim 1, wherein the central device is remote from the field of view detector.

4. The field of view detector of claim 1, wherein the field of view detector is configured to communicate an alert to the central device.

5. The field of view detector of claim 1, wherein the field of view detector is configured to communicate the orientation and/or location of the field of view detector to another field of view detector, and the field of view detector is configured to receive the location and/or orientation of another field of view detector.

6. The field of view detector of claim 5, wherein the field of view detector is configured to calculate a relative position and/or orientation of the other field of view detector.

7. The field of view detector of claim 1, the field of view detector comprising a direction indicator may be for indicating a direction in which to face.

8. The field of view detector of claim 1, wherein one or more of:
the orientation sensor is a compass;
the location sensor is a satellite positioning system locator or tracker; and/or
the communication system is a radio.

9. (canceled)

10. (canceled)

11. A central device comprising a processing device, a communication system and a display, the processing device configured to receive an orientation and a location from one or more field of view detectors, and configured to display the orientation and location of one or more field of view detectors using the display.

12. The central device of claim 11, wherein the central device is configured to display one or more of:
the location and/or orientation of one or more field of view detectors on a map and/or as numerical data,
a field of view using the orientation and location of one or more field of view detectors;
a plurality of fields of view of a respective plurality of field of view detectors; and/or
an aggregate or combined field of view of the plurality of fields of view of the respective plurality of field of view detectors.

13. (canceled)

14. (canceled)

15. (canceled)

16. The central device of claim 11, wherein the central device is configured to calculate and/or display an intersect or triangulation using the orientation and location of two or more field of view detectors.

17. The central device of claim 16, configured to calculate and/or display a line from each location of two or more field of view detectors, the lines orientated in the orientation of the field of view detectors and display the intersect or triangulation point as the intersection of the lines from the locations of each of two or more field of view detectors.

18. The central device of claim 11, wherein the central device is configured to display a location, orientation and/or field of view of a field of view detector, wherein the display of the location, orientation and/or field of view is representative of another property of the field of view detector and/or a user or wearer of the field of view detector.

19. The central device of claim 18, wherein an extent of an indicia representing an orientation or the extent of a field of view may represent a range of a field of view or of a weapon of the wearer or user of the field of view detector.

20. The central device of claim 11, configured to display the location, orientation and/or field of view representative of average or cumulative movements, orientations and/or other properties of the one or more field of view detectors and/or of respective users or wearers of the one or more field of view detectors over time.

21. A system comprising the central device and one or a plurality of field of view detectors; wherein
the one or each of the plurality of field of view detectors comprising an orientation sensor for determining an orientation of the field of view detector, a location sensor for determining a location of the field of view detector, and a communication system, the one or each of the plurality of field of view detectors being configured to communicate the orientation and location of the field of view detector to the central device using the communications system; and
the central device comprising a processing device, a communication system and a display, the central device being configured to receive the orientation and location from the one or the plurality of field of view detectors, and configured to display the orientation and location of the one or the plurality of field of view detectors using the display.

22. A method of displaying a field of view of a field of view detector, the method comprising:
using a location and an orientation of a field of view detector to set or define a field of view of the field of view detector; and
displaying the field of view of the field of view detector using a central device.

23. The method of claim 22, comprising one or more of,
defining a centre of the field of view of a field of view detector as an average orientation of the field of view detector over a period of time;
defining the width of the field of view of a field of view detector as a set value; and/or
a user or wearer of a field of view detector setting or determining the width of the field of view of a field of view detector.

24. (canceled)

25. (canceled)

26. A method of determining the location of a target or object, the method comprising:
receiving the location and orientation of two of more field of view detectors; and
triangulating the intersection of two or more of the two or more orientations.

27. A tangible computer readable carrier medium carrying a computer program product, wherein the computer program product is configured such that when implemented on a processing system, causes the processing system to,
use a location and an orientation of a field of view detector to set or define a field of view of the field of view detector, and
display toe field of view of the field of view detector using a central device.
